(19) United States
(12) Patent Application Publication
(10) Pub. No.: US 2024/0160645 A1
(43) Pub. Date: May 16, 2024

(54) SECURITY AND SAFETY TRACKING SYSTEM AND METHOD

(71) Applicant: Umpy Safe, LLC, Greenwich, NY (US)

(72) Inventors: Darryl Mabee, Ontario (CA); David Cerilli, Greenwich, NY (US)

(21) Appl. No.: 18/280,064

(22) PCT Filed: Mar. 1, 2022
(86) PCT No.: PCT/US2022/018276

§ 371 Date: Sep. 1, 2023

Related U.S. Application Data
(60) Provisional application No. 63/155,024, filed on Mar. 1, 2021.

(51) Int. Cl. G06F 16/29; G06Q 10/0635; H04W 4/021; H04W 4/90

(52) U.S. Cl. CPC G06F 16/29; G06Q 10/0635; H04W 4/021; H04W 4/90

(57) ABSTRACT

The present disclosure relates to systems and methods for customized risk assessment and safety tracking. The system may be in the form of a mobile web application or a device specific native application that aggregates risk data from a wide range of data sources and provides customizable filtering of the data for individuals or groups of individuals based on specific user selected values of preferred risk level. Exemplary risk data includes, but is not limited to, crime statistics, disease outbreaks, weather conditions, medical service and supply locations, fuel and food supply locations, and the like. The application may provide alerts, map overlays, route planning, and safety tracking for individual users or groups of users.

### CROSS-REFERENCE TO RELATED APPLICATIONS

This application claims priority to U.S. Provisional Patent Application Ser. No. 63/155,024 filed Mar. 1, 2021, which is incorporated herein in its entirety.

### TECHNICAL FIELD

The present disclosure relates generally to systems and methods for safety and security tracking based on selection of personal risk thresholds for a range of risks based on geographically linked risk related data, wherein the data is aggregated, validated, and filtered.

### BACKGROUND

The public at large do not have adequate access to concise and clear data indicating the safety of locales in which they are interested in visiting, traveling through, or investing financial and/or material resources. Compilation of data regarding crime, disease, and/or other risks of danger in such locales would be helpful. Specific safety and security issues of interest include but are not limited to, crime, pandemic, various health challenges, industrial risks, and forces of nature.

While many of these types of data may be individually available, they are generally provided in an inconsistent manner from disparate data sources, many of which may not be properly vetted, and are not customizable. Moreover, rapidly evolving events, such as political unrest, police action, medical emergencies, to name a few, are generally not reported in a manner easily accessible to a user, especially one currently en route to a location. As such, individuals lack the ability to assess their risks, such as when traveling through or to a location or when making financial decisions related to a specific location. With the proliferation of computing devices that can travel with a user (e.g., mobile phones, intelligent dashboards, smart wearables, and other mobile devices), there is an opportunity to provide the user with improved safety and security applications.

A number of safety applications are currently available, such as Watch Over Me, StaySafe, bSafe, React Mobile, On Watch, etc. Many of these applications rely on user reported data and indications of safety, which tends to be subjective and is often unverifiable. Additionally, certain of these applications may provide reporting of a user location to contacts or emergency responders, without further indications of risk or the ability to customize the reporting.

Accordingly, improved systems and methods for safety and security planning and tracking are desirable, and particularly desirable are systems that allow user specific filtering and configuration of risk data and assessment.

### SUMMARY

The present disclosure may be in the form of a mobile web application or a device specific native application that is directed to enhancing individual safety and security. The application aggregates a wide range of risk data and provides customizable filtering of the aggregated data for individuals or groups of individuals based on at least specific user selected values of preferred risk level, i.e., a user risk threshold. Exemplary risk data includes, but is not limited to, crime statistics, political unrest locations and severity, disease outbreak locations and severity, weather conditions, medical service and medical supply locations, fuel supply locations, and food supply locations. The application may provide alerts, map overlays, route planning, and real-time safety tracking for individual users or groups of users.

Accordingly, the present disclosure provides one or more computer storage media having computer-executable instructions embodied thereon that, when executed, perform a method for safety tracking. The method generally comprises accessing safety-related information from a data store on a server database, the safety-related information being compiled from at least one data source and being indexed by geographic region, and retrieving a user profile that includes a user risk threshold, such as from the server database or from a memory of the client device. The user risk threshold is compared to the safety related information for a specific geographic region, and a graphical user interface (GUI) may be generated on a client device, wherein the GUI may present either of (a) a binary output for the specific geographic region based on the comparing, wherein the binary output indicates a first action when the safety related information is less than the user risk threshold and a second action when the safety related information is greater than the user risk threshold, or (b) a risk overlay on a map representation of at least the specific geographic region, wherein the risk overlay presents a heat map based on the comparing.

The safety related information comprises a plurality of data fields that are individually graded by the user to generate the user risk threshold. The plurality of data fields may include data related to one or more of crime statistics, emergencies (e.g., political and social unrest, military and/or police actions, and the like), disease outbreaks, weather conditions, medical service locations, medical supply locations, fuel supply locations, lodging availability and locations, and food supply locations. According to certain aspects, the data included in the safety related information may be verified based on predetermined validation criteria, such as a total number of data points in a data set and/or a percentage of data points that are out of a set standard deviation limit.

The user profile may also comprise information related to user characteristics, such as one or more of a user age, gender, health status, mobility, and the like.

According to certain aspects, the user profile may comprise a separate user persona score based on such user characteristics, i.e., one or more of a user age, gender, health status, and mobility. The user persona score may comprise a preset grade for each of the plurality of data fields of the safety related information based on the user characteristics. A second user may select the user persona score and/or the user risk score for each member of a group of users, or for the group of users. When the user profile includes a user persona score, both of the user persona score and the user risk threshold are compared to the safety related information for a specific geographic region to generate either of the binary output or the risk overlay on the map representation.

When the specific geographic region is a current geographic location of the client device, the first action may be a stay or “safe” notification indicating the specific geographic region is safe and the second action may be a leave or “out” notification indicating the specific geographic region is unsafe. The method may wait a predetermined length of time for an acknowledgement signal to be received after a “leave” or “out” notification is sent to the client device, and in the event that the acknowledgment signal is not received, the method may send an alert signal to at least one second client device. The method may further yet send an alert to a second client device when the safety related information is greater than the user risk threshold even in the event that an acknowledgement signal is received from the client device.

The method may further comprise receiving a user entered destination location and one of a user entered origination location or an origination location of the client device, such as provided by a global positioning sensor of the client device, and may generate a route from the origination location to the destination location using, in part, the safety-related information. This route may be represented as a route overlay on the map representation of the GUI on the client device. The route may be an optimal route from the origination location to the destination location based on a route length and an aggregate risk factor, wherein the aggregate risk factor comprises aggregated safety related information for positions along a test route between the current geographic location and the destination location, and wherein the optimal route is the test route having the lowest combined route length and aggregate risk factor. The method may further comprise sending an alert to the client device and/or a second client device when the current geographic location deviates from the route after travel on the route has commenced, and/or representing a location of the client device on the second client device during transit on the route.

The method may further comprise signaling the client device to activate sensors thereon when the safety related information is greater than the user risk threshold. Exemplary sensors include one or more of an accelerometer, a gyroscope, a thermometer, a barometer, a proximity sensor, a compass, an ambient light sensor, a camera, an audio recorder, and a posture sensor. Data from at least one of the activated sensors may be recorded, and according to certain aspects of the method, the recorded data may be compared to a reference data set from the at least one sensor. If the recorded data deviates from the reference data, an alert notification may be sent to the second client device.

The present disclosure also provides a personal safety tracking and notification system comprising a server coupled to a wireless network and configured to communicate with a plurality of client devices, wherein the server is coupled to a database comprising safety-related information compiled from at least one data source and indexed by geographic region, and is further coupled to a processor configured to execute instructions that perform a method for safety tracking as disclosed herein.

### BRIEF DESCRIPTION OF THE DRAWINGS

The various embodiments described herein may be better understood by considering the following description in conjunction with the accompanying drawings.

FIG. 1 illustrates a threshold settings screen of a safety application according to certain aspects of the present disclosure.

FIGS. 2A-2B illustrate crime arrests and ranking screens for exemplary geographic locations according to certain aspects of the present disclosure.

FIG. 2C illustrates exemplary personas according to certain aspects of the present disclosure.

FIG. 3 illustrates a team safety dashboard of a safety application according to certain aspects of the present disclosure.

FIG. 4 illustrates a geographic safety concerns screen of a safety application according to certain aspects of the present disclosure.

FIG. 5 illustrates a safety concerns heatmap of a safety application according to certain aspects of the present disclosure.

FIG. 6 illustrates an anomaly pop-up screen of a safety application according to certain aspects of the present disclosure.

FIG. 7 illustrates an out-of-bounds travel path of a safety application according to certain aspects of the present disclosure.

FIG. 8 illustrates a user flow-path of a safety application according to certain aspects of the present disclosure.

FIG. 9 illustrates a block diagram of a system useful for implementation of a safety application in accordance with certain aspects of the present disclosure.

### DETAILED DISCUSSION

The present disclosure describes safety and security systems and methods. The systems and methods address the needs of individuals, small groups, and even large groups to monitor and track safety risks. For example, the systems and methods may inform user(s) whether a current location is safe or not safe, such that the user(s) know whether to stay or go (i.e., safe or out). As additional examples, the systems and methods may provide data useful for tracking safety risks during travel to or through geographic locations, and/or may be useful for decisions regarding financial and/or material investments in a location. For example, should an individual or group live, shop, dine, play, drink, and/or invest in a specific geographic area.

The systems and methods achieve these results by aggregating and validating risk data from a wide range of data sources and providing customizable filtering and grading of a plurality of data fields for individuals or groups of individuals based on user or group specific risk level preferences.

Prior to setting forth the various aspects of the present disclosure in greater detail, it may be helpful to an understanding thereof to set forth definitions of certain terms to be used hereinafter.

### Definitions and Abbreviations

As generally used herein, the articles “one”, “a”, “an” and “the” refer to “at least one” or “one or more”, unless otherwise indicated. As generally used herein, the term “about” refers to an acceptable degree of error for the quantity measured, given the nature or precision of the measurements. Typical exemplary degrees of error may be within 20%, 10%, or 5% of a given value or range of value. Alternatively, the term “about” refers to values within an order of magnitude, potentially within 5-fold or 2-fold of a given value.

All numerical quantities stated herein are approximate unless stated otherwise. Accordingly, the term “about” may be inferred when not expressly stated. The numerical quantities disclosed herein are to be understood as not being strictly limited to the exact numerical values recited. Instead, unless stated otherwise, each numerical value is intended to mean both the recited value and a functionally equivalent range surrounding that value. At the very least, and not as an attempt to limit the application of the doctrine of equivalents to the scope of the claims, each numerical parameter should at least be construed in light of the number of reported significant digits and by applying ordinary rounding techniques. Notwithstanding the approximations of numerical quantities stated herein, the numerical quantities described in specific examples of actual measured values are reported as precisely as possible.

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this disclosure is intended to include all lower numerical limitations subsumed therein and any minimum numerical limitation recited in this disclosure is intended to include all higher numerical limitations subsumed therein. Accordingly, Applicants reserve the right to amend this specification, including the claims, to expressly recite any sub-range subsumed within the ranges expressly recited herein.

Note that various terminology used herein can imply direct or indirect, full or partial, temporary or permanent, action or inaction. For example, when an element is referred to as being “on,” “connected,” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Moreover, terms “comprises,” “includes,” “has” or “comprising,” “including,” “having” when used in this specification, specify a presence of stated features, integers, steps, operations, elements, or components, but do not preclude a presence and/or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

As used herein, the terms “group” and “team” are interchangeable and may be understood to relate to any group of individuals, and in particular to groups of individuals that are linked by a common interest, such as family members, coworkers, commercial organizations, public organizations or groups, etc.

As used herein, the term “safe” may be generally understood to indicate that safety related information for a specific geographic region is equal to or less than a user risk threshold value while “unsafe” may be generally understood to indicate that the safety related information for a specific geographic region is greater than a user risk threshold.

Additionally, although terms first, second, and others can be used herein to describe various elements, components, regions, layers, or sections, these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section without departing from this disclosure.

All terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

In addition, features described with respect to certain example embodiments may be combined in or with various other example embodiments in any permutational or combinatory manner. Different aspects or elements of example embodiments, as disclosed herein, may be combined in a similar manner. The term “combination,” “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity or actor in any manner.

In the following description, certain details are set forth in order to provide a better understanding of various embodiments of the safety and security system and methods disclosed herein. However, one skilled in the art will understand that these embodiments may be practiced without these details and/or in the absence of any details not described herein. In other instances, well-known structures, methods, and/or techniques associated with methods of practicing the various embodiments may not be shown or described in detail to avoid unnecessarily obscuring descriptions of other details of the various embodiments.

### Specific Embodiments of the Present Disclosure

The systems and methods of the present disclosure allow users to grade specific risk categories based on personal risk-avoidance preferences, and receive a signal indicating whether their current geographic location is safe or unsafe, i.e., “safe” or “out”, based on aggregated and validated risk data from a wide range of data sources. The method may further provide alerts, map overlays, travel route planning, travel rerouting, and safety tracking for the individual user, and/or for groups of users (e.g., family members, school groups, work groups, etc.).

The method generally includes allowing a user to grade a plurality of risk data fields of safety related information to create a user risk threshold that may be stored as part of a user profile. The user profile may also include a persona and persona grade for the plurality of risk data fields. The persona is generally based on user characteristics, such as one or more of a user age, gender, health status, and mobility. For example, exemplary persona may be based on age, such as grouped to include users less than 25 years old, users between 25 and 50 years of age, and users greater than 50 years old; and/or based on gender; and/or based on health status, such as users with disabilities and health conditions (e.g., user on crutches or wheel chair bound), users who are very active, etc. While certain nonlimiting examples of persona have been described, other characteristics may be considered when creating a persona. Moreover, specific grades for individual risk data fields may be set and/or changed as persona are created or re-evaluated.

Selection of the user's risk threshold may be executed on formation of the user profile, such as when setting up a user account on a system performing the methods of the present disclosure. Setup of the user account may include creation of standard account information, e.g., user login name and password, biometric identification is available, device specific characteristics, home address, account linkages (i.e., member of a group, family, company, etc.), and may allow the user to grade the plurality of risk data fields of safety related information. The user account may later allow the user to change password and/or to change their risk threshold, such as based on changes in travel mode (i.e., is the user on foot, traveling by car or train, etc.), changes in travel companions (e.g., is the user traveling alone, with a healthy companion, or with a child or elderly companion), changes in the user's health status (i.e., recent injury or change in the user's level of mobility), etc.

Setting a user's risk threshold may include grading or regrading each of the full list of risk data fields, or may allow grading or regrading of data fields that are provided as categories or subcategories (e.g., subcategories of crime such as crimes against a person versus crimes against property). For example, the user may select a preset risk threshold based on mobility (e.g., active person traveling by car, elderly woman walking to an event, etc.), or may change their previously set risk threshold based on a time of day (e.g., change risk aversion by a set amount or percentage, such as increase grade for the data fields of rape and assault by 25% for user traveling at night), or travel companion, or length of travel, etc.

Selection of the user's persona or persona score may be based on information provided during setup of the user's account, such as from queries related to any of age, gender, activity level, and health status of the user. The user's persona may also be changed, such as based on a change in health status or age. Moreover, as with the setting the user's risk threshold discussed above, grading of risk data fields may be changed (e.g., regraded or changed by a specific percent) individually or as categories or subcategories.

The user risk threshold and/or persona may be set by the user, or may be set by a second user, such as an administrator of a group of users. For example, a group of users may comprise members of a family, students of a class, or employees of a company. Accordingly, reference herein to a second user or second user device may be reference to an administrator. Alternatively, or additionally, a second user may be selected by a user as an emergency contact, such as a family member or partner or best friend, or team member. As such, the second user may refer to an account administrator (e.g., teacher for a class of students), and also to an emergency contact (e.g., parent or family member). The second user may also be able to select or change when certain alerts are sent to various users and/or what users receive certain alerts (ono-to-one, one-to-many, many-to-one, mutually exclusive or exclusive to one, etc.), when the method is active for a user or the user's client device (e.g., only during work hours), and/or may override or change any of the other user selected settings.

The method may access the user profile along with safety-related information that is indexed by geographic region, such as the user's current geographic location, and may compare at least the user's risk threshold to the safety related information. When the user profile also includes a user persona, the method may further comprise comparing the user risk threshold and the user persona to the safety related information. If the safety related information includes risk data field scores that are less than the user risk threshold, and/or combined user risk threshold and user persona, the method may signal to the user that their current geographic location is safe. However, if the safety related information includes one or more risk data field scores that are greater than the user risk threshold, and/or combined user risk threshold and user persona, the method may signal to the user that it is unsafe, i.e., may send a leave message. Alternatively, or in addition, the method may provide a map showing at least the user's current geographic location and an overlay on the map that illustrates the risk level (i.e., based on the comparison of the user's risk threshold to the safety related information), such as a heat map.

If an unsafe signal is indicated and communicated to the user, the method may wait a predetermined length of time for an acknowledgement signal to be received. In the event that the acknowledgment signal is not received, the method may send an alert signal to at least one second user. The method may further yet send an alert to the second user when the safety related information is greater than the user risk threshold even in the event that an acknowledgement signal is received from the user.

The method may further comprise receiving a user entered destination location and a user entered origination and may generate a route from the origination location to the destination location using, in part, the safety-related information. This route may be represented as a route overlay on a map. The route may be an optimal route from the origination location to the destination location based on a route length and an aggregate risk factor, wherein the aggregate risk factor comprises aggregated safety related information for positions along a test route between the current geographic location and the destination location, and wherein the optimal route is the test route having the lowest combined route length and aggregate risk factor. As such, the method may compare the safety related information for positions along each test route to the user profile (i.e., user risk threshold and/or user persona). This may be done once to calculate the optimal route, and may also be done continuously during travel along the first calculated optimal route (i.e., continuous recalculation to account for deviations from the first calculated route and/or changes in the safety related information or changes to the user profile).

The method may send an alert the user and/or to a second user when the current geographic location of the user deviates from the optimal route after travel on the route has commenced. The method may also provide notification of a location of the user, such as via coordinates or a location on a map representation, to the second user during transit of the user on the route.

The safety related information may be aggregated from a wide range of data sources and is geographically indexed. Exemplary data sources include, but are not limited to, crime statistics, disease outbreaks and severity, weather conditions, medical service locations, medical supply locations, fuel supply locations, food supply locations, locations of police and fire stations, locations of defibrillators, etc. One or more data fields may represent the data from each category. For example, crime statistics may include data fields describing individual crime types, such as arson, aggravated assault, burglary, larceny-theft, murder, rape, robbery, property crime, motor vehicle theft, and violent crimes. As another example, weather conditions may include data fields describing specific weather conditions and emergencies, such as rain, snow, tornado, tropical storm, wind speed, temperature, etc. Moreover, data types such as medical service locations, medical supply locations (e.g., pharmacies, drug stores, etc.), food locations (e.g., grocery stores, restaurants, etc.), fuel locations, police and fire stations, etc. may include fields that rank these data types based on number, quality, and/or distance from the users current geographic location.

The methods of the present disclosure may be implemented in the form of a mobile web application or a device specific native application. As such, the present disclosure provides one or more computer storage media having computer-executable instructions embodied thereon that, when executed, perform the method. A user may access the method on a network enabled electronic device comprising at least a processor and a memory, wherein the memory stores processor executable code configured to initiate or execute at least one step of the method (i.e., at least link to a server database comprising the safety related information indexed by geographic region).

Accordingly, communication and selections described as related to a user may comprise signaling to/from a client device, such as a portable electronic device (e.g., mobile phone, table, etc.). Accordingly, a current geographic location of the client device may be user entered or may be determined by a GPS sensor on the client device. The method may generate a graphical user interface (GUI) on the client device that presents results of a risk assessment for the current geographic location (i.e., comparison of the safety related information for the current geographic location with the user profile that includes the user risk threshold and optionally the user persona). The results may be presented as either of (a) a binary output for the specific geographic region based on the comparing, wherein the binary output indicates a first action when the safety related information is less than the user risk threshold and a second action when the safety related information is greater than the user risk threshold, or (b) a risk overlay on a map representation of at least the specific geographic region, wherein the risk overlay presents a heat map based on the comparing. As mentioned above, the first action may be a stay or “safe” notification indicating the specific geographic region is safe and the second action may be a leave or “out” notification indicating the specific geographic region is unsafe.

The method may wait a predetermined length of time for an acknowledgement signal to be received after a “leave” or “out” notification is sent to the client device, and in the event that the acknowledgment signal is not received, the method may send an alert signal to at least one second client device. The method may further yet send an alert to a second client device when the safety related information is greater than the user risk threshold even in the event that an acknowledgement signal is received from the client device.

The method may also include sending signals to the client device to activate sensors thereon. Exemplary sensors include one or more of an accelerometer, a gyroscope, a thermometer, a barometer, a proximity sensor, a compass, an ambient light sensor, a camera, an audio recorder, and a posture sensor. See Table 1 for an extended list of possible sensors that may be activated on a client device. The specific sensors activate/activatable on the client device may be understood at startup of the method on the client device, or may be input/understood during account formation, such as on the client device. Data from at least one of the activated sensors may be recorded, and according to certain aspects of the method, the recorded data may be compared to a reference data set from the at least one sensor. If the recorded data deviates from the reference data, an alert notification may be sent to the second client device. In this way, the method may be useful for tracking the safety of family members and/or employees, such as during work hours, etc.

TABLE 1

| | | |
|---|---|---|
| accelerometer | magnetic field | orientation |
| gyroscope | light | pressure |
| temperature | proximity | gravity |
| linear acceleration | rotation vector | relative humidity |
| ambient temperature | magnetic field uncalibrated | on vector |
| gyroscope uncalibrated | significant motion | step detector |
| step counter | geomagnetic rotation vector | heart rate |
| tilt detector | wake gesture | glance gesture |
| pick up gesture | wrist tilt gesture | device orientation |
| pose 6dof | stationary detect | motion detect |
| heartbeat | dynamic sensor meta | additional info |
| low latency off | accelerometer uncalibrated | hinge angle |
| body detect | | |
| Barometer | fingerprint | facial recognition |

The method may also include sending signals to the client device to activate sensors in certain situations, such as when the safety related information is greater than the user risk threshold, i.e., record data during a possible emergency or unsafe situation. This data may be recorded and send to a second client device, such as a device of a second user, i.e., administrator or emergency contact.

The method may also provide emergency call buttons updated for the current location, such as buttons that will direct dial 911, the closest hospital, the closest pharmacy, etc. The method may also provide emergency locations and/or directions thereto, such as the location and/or directions to the closest hospital, pharmacy, police station, food or fuel location, etc. These may be found on a user dashboard of the system and may be represented by simple buttons the user may push to activate a call or gain directions.

The method may also provide static buttons on a user interface of the client device, such as phone call buttons to user or administrator selected contacts, e.g., friends and/or emergency contacts and/or team members, a settings menu button, a voice control panel and/or buttons, an alert notification acknowledgement button, and the like.

The present disclosure also provides a personal safety tracking and notification system comprising a server coupled to a wireless network and configured to communicate with a plurality of client devices, wherein the server is coupled to a database comprising safety-related information compiled from at least one data source and indexed by geographic region, and is further coupled to a processor configured to execute instructions that perform the method(s) for safety tracking disclosed herein.

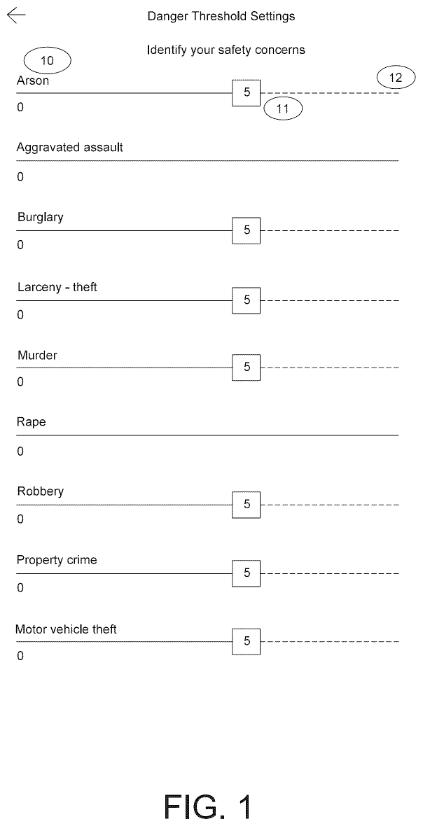

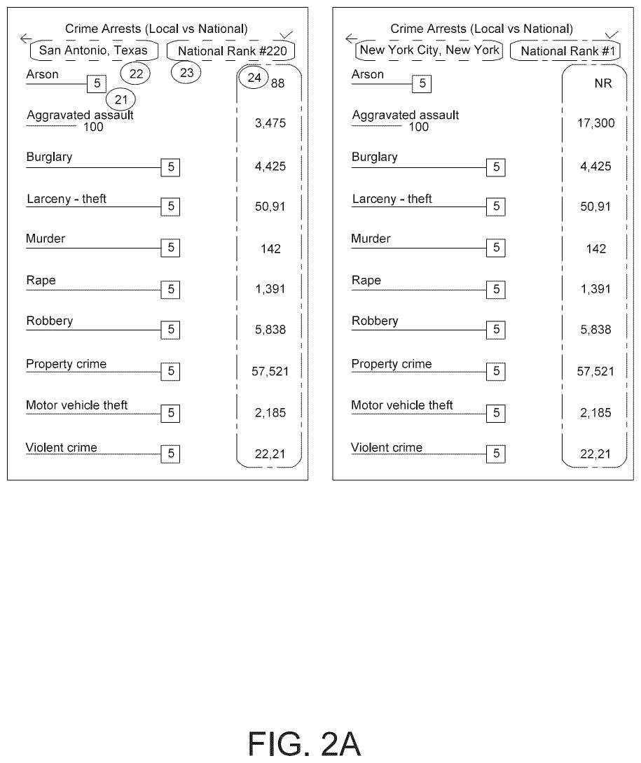

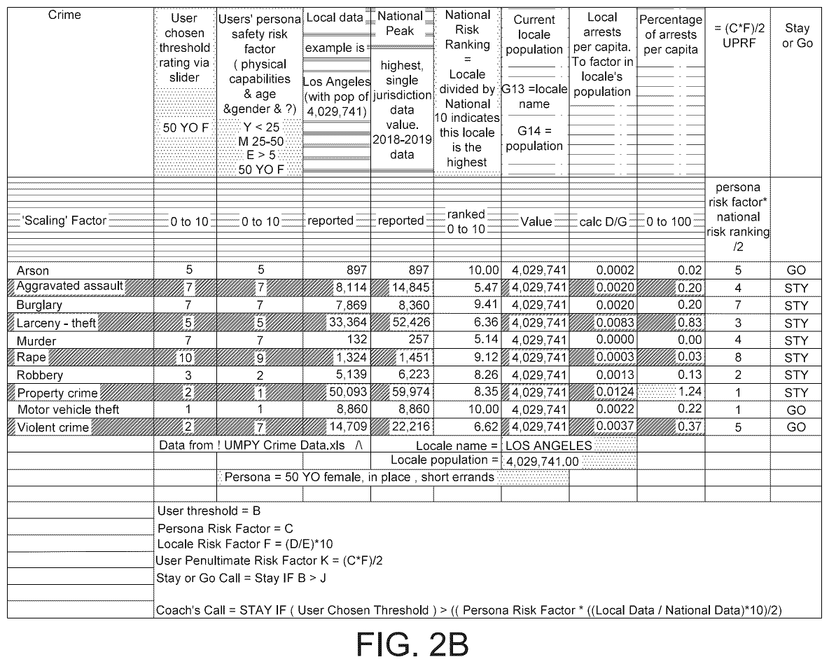

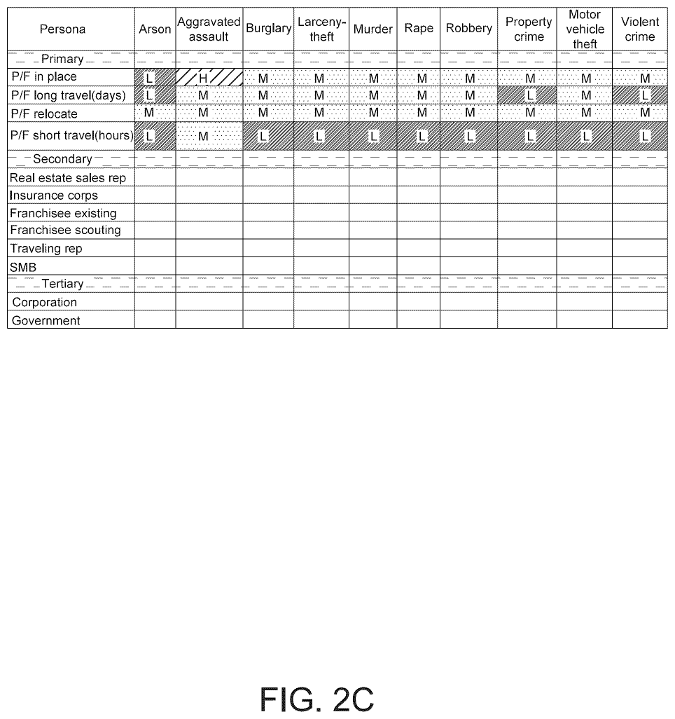

The presently disclosed system and method will be further discussed with specific reference to the figures. The methods disclosed herein aggregate and validate a list of data fields related to various risk categories and allow customization of their individual relevance to the user to generate a preferred risk avoidance score, i.e., user risk threshold. As shown in FIG. 1, the system may be configured to present a user with a dashboard where the user may select their user safety level 11 from a wide range of data fields 10, in this case crime categories. As shown, the user may make the selection by moving a slider between a minimum safety level (i.e., “0”) and a maximum safety level 12 (i.e., “10”). Shown in FIGS. 2A and 2B are raw crime data 24 (i.e., per category volume of arrests) for a location of concern 22 along with a national ranking 23 for the location, and a user selected safety level 21.

While the dashboard of FIGS. 1 and 2 show specific types of crimes and data, other crime data can be included in addition to other data types (i.e., weather concerns, heath concerns, etc.) on the same or additional dashboards. Sources of data that may be aggregated according to the present disclosure include, but are not limited to, crime statistics, disease outbreaks, weather conditions, medical service and supply locations, fuel supply locations, and food supply locations. Crime data may include raw numbers and/or statistics related to one or more of reported arson, aggravated assault, burglary, larceny-theft, murder, rape, robbery, property crime, motor vehicle theft, and violent crime.

The data may be aggregate data that is not separated or filtered for race, gender, or age (i.e., is a sum of all data for a specific category, such as all arrests for each of the crime categories). Moreover, the data may be validated against predetermined validation criteria for quality, such as validating that the data of each data field includes a sufficient number of total data points, and/or that the data is of sufficient quality to eliminate data points outside of a set standard deviation limit, and/or that only a small percentage of the data is outside of a set standard deviation limit, and/or that all of the data is within +2 or +3 standard deviation. For example, data may be aggregated and validated according to standard preset validation criteria that includes either or both of a total number of data points in a data set and a percentage of data points that are out of a set standard deviation limit.

Data for various data fields may not be available for certain jurisdictions, i.e., geographic regions, or may be of poor quality, such as determined by validation against the predetermined validation criteria. In such an instance, those data fields would be omitted from the safety related data used to determine a safe or out comparison.

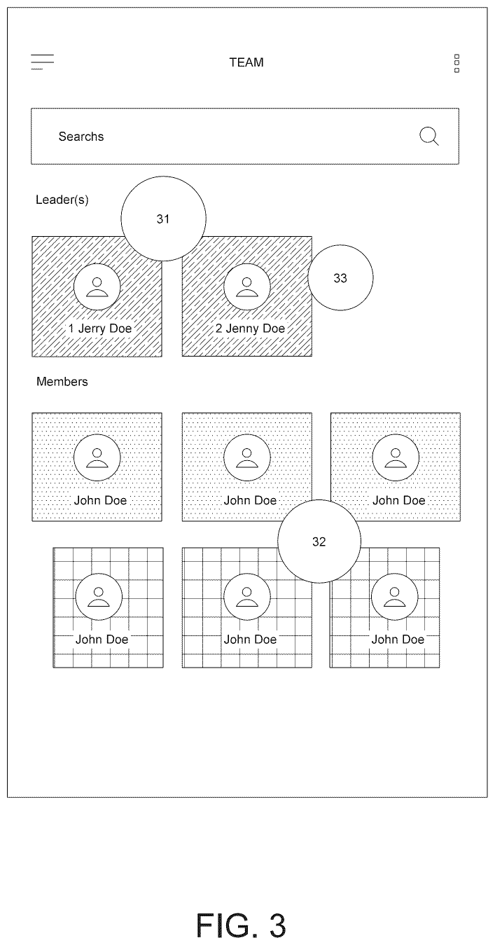

Individuals may control data sources and relevance of individual data sources in a user specific profile. Moreover, members of a group or team may control data sources and relevance of individual data sources based on a group or team profile, such as chosen by a group head or manager (i.e., only the team leader may access the safety level selection dashboards shown in FIGS. 1 and 2A). For example, as shown in FIG. 3, a team safety dashboard may show team leaders 31 and team members 32. For such groups, designated group administrators (leaders in FIG. 3) may be provided with a notification when a member is out of the service area, their mobile device is turned off, or when the profile is altered. Moreover, the overall safety of individuals in the group may be represented on such a dashboard as a color, such as green for safe and red for unsafe, based on scoring algorithms detailed hereinbelow. While described as a color-coded system, any other means, such as text or numeric designations are also possible.

Customization of data may be based on specific safety expectations and risk level comfort. For example, more stringent risk level selection and reporting (i.e., reporting triggered at lower crime, disease, etc. levels) may be customized for at-risk individuals or groups, such as school students or the elderly. Customization of the data may also be based on any number of other user selected or defined factors and/or may be customized for specific situations, such as standard employee expectations, unique family member profiles, driver delivery location monitoring during working hours, monitoring of students for a school trip, monitoring of individuals in a group for specific events, etc. Accordingly, in addition to providing individual users with a means to assess their safety and security, the currently disclosed system provides a means for groups to monitor the safety of individuals within the group such as, for example, family members or coworkers.

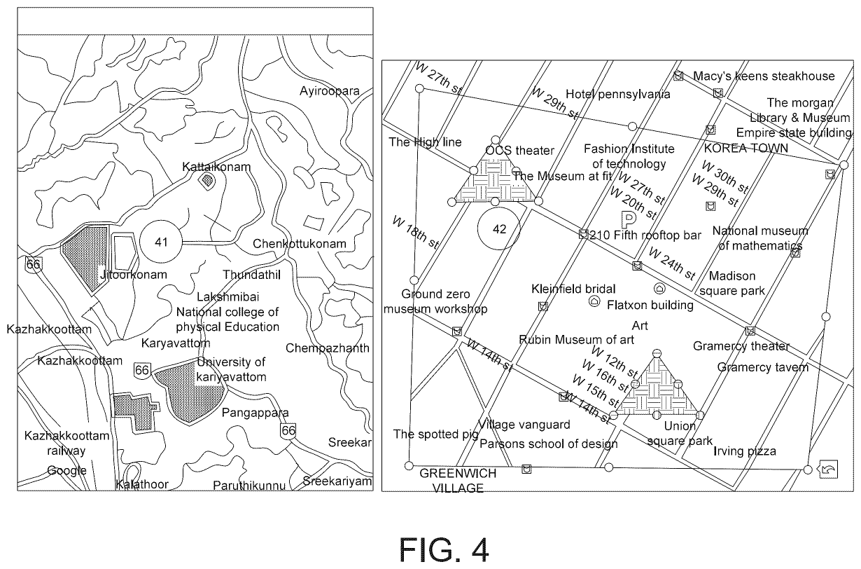

The individual safety data and statistics on which the presently disclosed system may rely generally include data relevant to a selected or current Zip Code, such as shown in FIG. 4. For example, risk or danger levels that are above the user or group defined risk threshold scores may be represented as red overlay on a map that includes the selected or current geographic region (i.e., a map that shows selected areas within a wider radius of geographic region). As shown in FIG. 4, certain areas, such as defined by a 5-digit zip code 41 or a 9-digit zip code 42, may have high risk or danger scores and may appear red on a map.

When the assessment is based on a current location, the location data may be obtained from a global positioning system or sensor of the client device, or may be entered by the user.

The risk assessment may be based on a binary output for the selected or current geographic region. That is, a binary “Stay” or “Go” output (e.g., safe or out) may be provided to a user based on a relationship between the safety related information for the selected or current geographic region and the preferred risk avoidance score. Thus, values above the preferred risk avoidance score may trigger a “Go” response and those below the preferred risk avoidance score may trigger a “Stay” response from the system and method. Alternatively, the binary output may be represented graphically, such as shown in FIG. 4, by an overlay of a colored region for go (red), and uncolored regions for stay.

The risk assessment may be based on an algorithm that compares the user risk threshold and the risk data for the current geographic location. The risk assessment may be based on an algorithm may compare the user risk threshold against a combination of the user persona and the risk data for the current geographic location. A specific algorithm for risk assessment may be based on a comparison of the user risk threshold against a combination of the user persona and a ratio of the risk data for the current geographic location versus the national risk data:

STAY if (user risk threshold)>((persona risk factor)*((local data)/national data)*10/2)

GO if (user risk threshold)≤((persona risk factor)*((local data)/national data)*10/2)

With reference to FIG. 2B, the algorithm listed above for calculating a risk level, i.e., comparing the safety related information for a specific geographic region with a user risk threshold and user persona is shown, wherein the results are for a 50-year-old woman running short errands in Los Angeles California. As is apparent from the risk threshold (second column), the user is least concerned about motor vehicle theft, and most concerned about rape. Moreover, her persona (third column) shows that she is likely more vulnerable to crimes against her person due to her age and gender. The calculated resultant rating using the above algorithm is shown in the last column of the table in FIG. 2B, wherein the algorithm shows the user should be warned about arson, violent crime, and motor vehicle theft.

Various methods for determining persona scores or risk factors are possible. One such method provided risk scores as shown in FIG. 2B. Another method for defining individual risk levels or scores for various data fields is shown in FIG. 2C. For example, the personas for a person or family (P/F) in place, on a long trip, relocating, or on a short trip (see column 1) are shown, wherein the highest ranked concern is for aggravated assault. Also shown in FIG. 2C are other categories of persona, such as based on a job type, and/or employer type.

While a specific algorithm is indicated above, various other algorithms for providing a risk assessment and/or STAY or GO decision are possible and within the scope of the present disclosure.

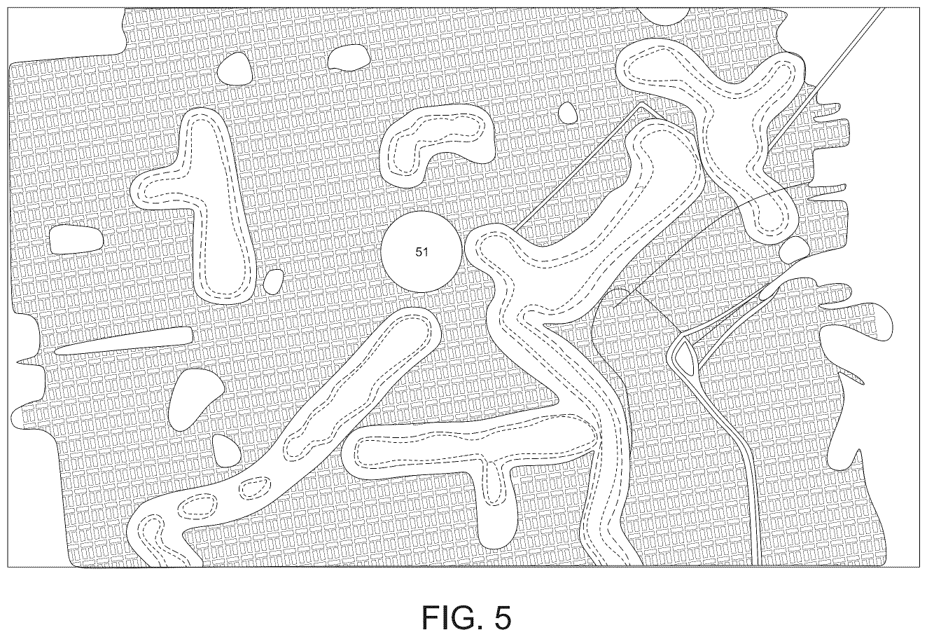

The risk assessment may be output to the user as a gradient of risk, wherein anything below the preferred risk avoidance score (i.e., comparison of the safety related data for the specific geographic location and the risk threshold and persona) would register as baseline and those values above the preferred risk avoidance score would be represented as values relative to the safety related information for the selected or current geographic region (i.e., as a gradient of colors, or dots, or numbers representing higher and lower relative risk). An exemplary risk gradient or heatmap is shown in FIG. 5, wherein regions having risk scores above the risk avoidance score are colored according to a relative statistical value (green to red, wherein red represents high risk levels).

Either or both of the binary data may be presented to the user on a graphical user interface (GUI) of a computing device, such as a stationary or mobile computing device. Exemplary devices include at least desktop and laptop computers, and mobile phones and tablets. The data may be presented as an overlay on a map of a geographic region (i.e., as shown in FIGS. 4 and 5), wherein the overlay may show the binary or gradient representations of the risk assessment for the specific user (i.e., based on that user's or group's preferred risk avoidance score).

As the user travels, the system may correlate the risk assessment data to the user's current geographic location and provide a current or real-time risk assessment or ‘danger score,’ allowing the user to decide to “Stay” or “Go” (i.e., “Safe” or “Out”). Such data may also be sent to a second client device, such as a computing device of another member of a group, and/or a user selected individual, and/or an administrator.

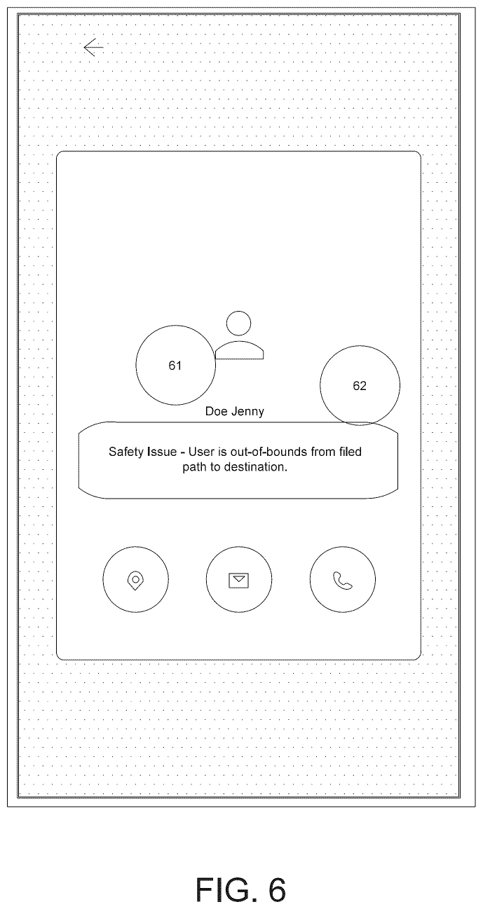

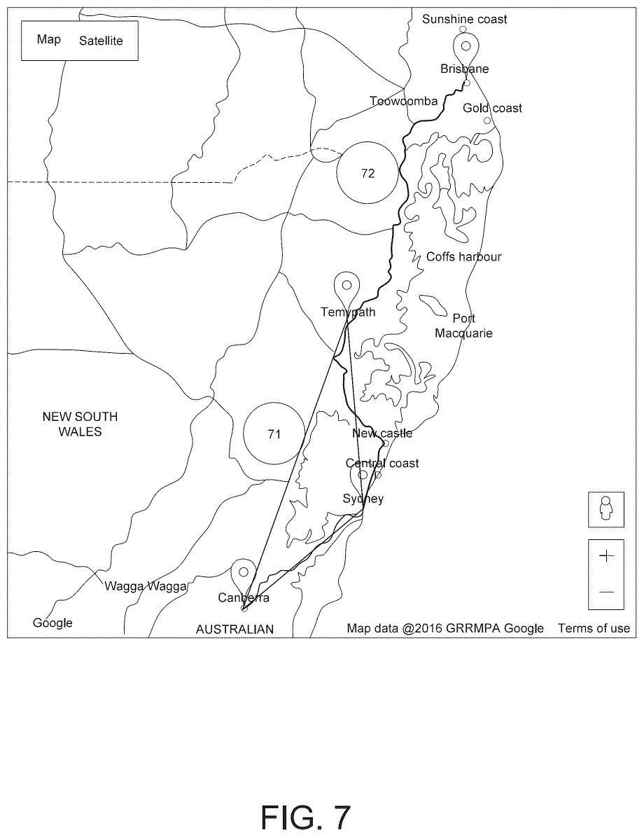

The systems and methods of the present disclosure may further provide risk assessment and alerts for a planned trip. For example, the system may be configured to receive a destination location, such as via user input on a dashboard, and an origination location. The original location may be a user selected location, input to the system on the same dashboard, or a current location of the user's computing device (e.g., mobile phone), wherein the current location of the user's computing device may be provided by a global positioning sensor of the computing device. The system may then generate a route between the origination location and the destination location using, in part, the safety-related information, and may represent that route as the overlay on a map presented on the graphical user interface of the user's device, such as shown in FIG. 7, wherein the selected route is mapped 71. Should the user deviate from the selected route, such as shown by line 72 (i.e., out of bounds travel), an alert may be sent to the user's device, and/or to other devices of groups members, or as selected by the individual user in the user profile. Such an alert is shown in FIG. 6, which depicts the user 61 and the alert message 62 conveyed to the user.

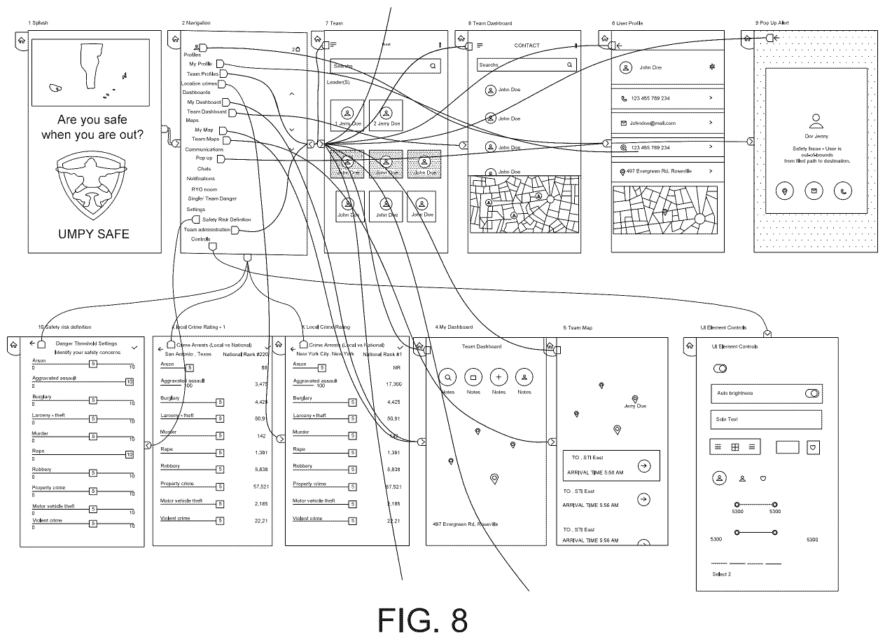

An overall map of a user's flow path through a system according to the present disclosure is shown in FIG. 8, wherein the lines represent movement between screens in the system based on at least user selections on a prior screen. An exemplary system may provide registration screens (screen 2—overall navigation screen; screen 7—team screen; screen 8—team dashboard; screen 6—user profile; screen 10—user risk threshold grading; etc.) for input of user specific account information, user risk thresholds, user personas, and other information relevant to setting up a user account (home address, home phone, email address, etc.). The user may also be able to select preferred display views of the alert and location specific risk information, e.g., binary notification or map such as a heat map, area range in miles of the map view, specific statistics for selected geographic regions, etc.

The exemplary system may also include dashboard screens that provide information about the user's current location and a map of other team members, and/or popup alert screens. Exemplary popup alert screens may indicate the binary stay or go directive; may include alerts sent by other team members, a team administrator, or an emergency contact, among others; may include alerts from the emergency broadcast system; may include amber alerts; may alert the user that their client device is out of cell and/or messaging (SMS) service, i.e., signal strength; etc.

According to certain aspects, the systems and methods of the present disclosure may also allow user input of relevant safety related data, such as user reporting of crime, weather, social unrest, traffic conditions, etc. Such data may be verifiable, validated, and/or may be provided as additional data sources for the aggregated data, such as stored on a server database. If unverifiable, such data may be limited for use by a specific group, such as a group to which the reporting user belongs.

According to certain aspects, the systems and methods of the present disclosure the system may provide feedback analysis of individuals and/or groups on behavior relative to statistics gathered. The system may further gather and maintain a travel history for tracking last whereabouts of individual users or groups of users, and may adjust emergency contact info to current location. For example, prior to traveling, a user may enter specific emergency contact information. When the system detects a risk threshold event while at the designated destination, an alert may be sent to the emergency contact in that location rather than the user's home location. In a similar manner, should the user be a member of a large group, such as an international or large national corporation, should an employee of the corporation trigger a risk threshold event on their device while traveling for work, the system may contact the local office at the travel location and not the home office of the employee, or may contact both the local and home offices. Thus, the system and methods of the present disclosure provide tools for management of teams both in organizing their safety criteria metrics, and data filtering.

According to certain aspects, the systems and methods of the present disclosure may also provide public alerts, such as from the police, 911, emergency system, and amber alerts. The system may also be configured for tracking of “chipped” items, such as vehicles, valuables or even pets having positioned thereon a trackable device such as a GPS or RFID chip.

While a large range of data sources have been mentioned and discussed herein, the list of possible sources is extensive. Certain exemplary data sources may include any combination of sources selected from the following:
(1) arrests per state in the US and reporting agency, e.g., https://crime-data-explorer.fr.cloud.gov/explorer/state/pennsylvania/arrest;
(2) Crime, such as expanded crime datasets in addition to arrests, e.g., https://crime-data-explorer.fr.cloud.gov/https://rapidapi.com/yourmapper/api/crimescore https://rapidapi.com/collection/city-data-api https://risk.lexisnexis.com/law-enforcement-and-public-safety/crime-analytics-and-mapping https://communitycrimemap.com/https://www.fbi.gov/services/cjis/ucr/nibrs https://communitycrimemap.com/https://www.raidsonline.com https://internationalsales.lexisnexis.com/nexis-daas
(3) medical issues past and live, e.g., https://journals.plos.org/plosone/article?id=10.1371/journal.pone.0225193;
(4) specific information related to Covid-19, e.g., Johns Hopkins University—CSSEGIS and Data/COVID-19, https://disease.sh/docs/, https://covid19.who.int/, https://www.programmableweb.com/api/covid-19-health-hotline-rest-api-v10, https://www.programmableweb.com/coronavirus-covid-19, https://github.com/CSSEGISandData/COVID-19 https://covid-19.ontario.ca/data
(5) pharmaceuticals, medications, over the counter items,
(6) fuel stations, so users don't get stranded, https://developer.nrel.gov/api/alt-fuel-stations/v1/nearest.json?api_key=465J3KX9NAcLfB3C3Nh49x3CFWuSbikNZ9CjLvEi&location=Denver+CO
(7) public, local, or network reported news past and live, e.g., aggregated, collated news sources;
(8) social media aggregation, e.g., any listed at https://en.wikipedia.org/wiki/List_of_social_networking_services, https://blackplanet.com, https://Gapyear.com;
(9) user input data, such as from members of a group or from all users of the presently disclosed system and methods;
(10) safety issues, such as food source/distribution challenges, EPA reports, forest fires, pests (e.g., ticks), industrial accidents, earthquakes/seismic events, floods, hurricanes, travel advisories, public alerts, emergency services numbers (police, ambulance, fire), amber alerts, protest alerts, IT alerts, security threat notifications (e.g., Cert.org, https://uscert.cisa.gov/, or https://www.programmableweb.com/category/safety/api).

Additional exemplary data sources include at least:
https://www.foia.gov/about.html (Freedom of Information Act or FOIA);
https://academic.oup.com/bioinformatics/article/27/12/1691/255399;
https://www.esri.com/en-us/arcgis/products/arcgis-insights/overview; https://api.usa.gov;
https://api.data.gov/; and
https://community.ibm.com/community/user/watsonstudio/blogs/douglas-stauber/2016/02/26/are-chicago-crimes-and-temperature-linked?.

The system and methods of the present disclosure may additionally provide predictive modeling of user behavior and/or past risk assessments for a selected geographic region. Such data may be useful to helps users leverage aggregated data and make decisions regarding the choice of data sets and modeling for future assessment results. Moreover, such predictive analysis may prove useful to uncover potential future action paths (e.g., related to travel) and or for business intelligence to enable users to access, analyze, and share information to improve decision-making through gathering metrics (e.g., decisions regarding financial or material investment). For example, such aggregate data may provide insight into specific data streams, such as traffic patterns, e.g., vehicular, pedestrian, nautical, and/or aerial, and safety issues related to such traffic paths, e.g., dangerous intersections, roads, etc.

The systems and methods of the present disclosure may also prove useful for individual and/or group planning purposes such as, for example, rental car options, corporate travel, trucking routes and stops, college choice, police resource allocation, management in crisis areas (Red Cross), community planning/management, real estate—property ranking, walk scoring for communities or properties, and insurance—qualifying and quantifying risk.

The systems and methods of the present disclosure provide aggregated data that is filterable according to specific user defined risk limits or comfort levels. Thus, while certain of these data may be available from data sources on their own, in an unaggregated and unfiltered manner, they are not capable of providing the user with accessible and configurable information that may guide decisions related to safety and security. You can't judge a town by its sidewalk conditions. Crime tends to follow money. The risk to affluent areas has risen in some cases. Facts and figures speak the truth, not as certain bodies wish to portray. Moreover, each person has their own knowledge of and/or definition of safety—therefore a user profile will be paramount to delivering an acceptable user experience

The presently disclosed systems and methods further provide access to a dashboard that allows the user to configure these personalized risk avoidance score, to view risk data or a danger score for specific user selected geographic region(s) or a current location (e.g., as an overlay on a map of the geographic region), to select notification parameters and thresholds, and to map a route based on analysis of the risk or danger score along the geographic region between the start and end point of the trip. Moreover, as mentioned above, risk data for specific locations may be useful toward providing an overall portrait of the safety issues surrounding a specific locale.

For groups, the presently disclosed system and methods may provide team leaders or managers with an indication of their teams' safety, i.e. manage by exception, via a RYG traffic-light dashboard and/or mobile app icon, and/or specific notification(s) with external trending metrics of safety and measurements.

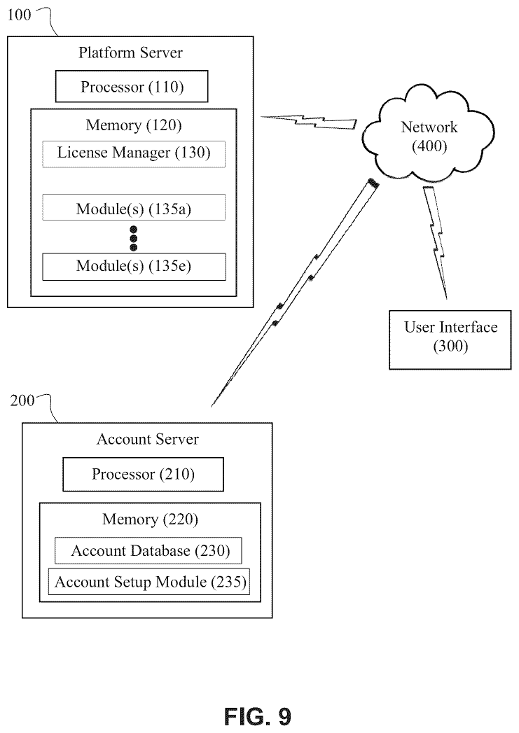

An overview of an exemplary system architecture is shown in FIG. 9. The system may include a platform server 100, an account server 200, and a user interface 300, all accessible over a network 400. The platform server may comprise the software application which can be presented over any one or more communications network(s) 400 (e.g., public or private) that provide access to the internet. Exemplary networks include at least wide-area-networks (e.g., WANs, cellular data networks, satellite data networks, fiber-optic networks, and/or other information networks capable of enabling communications over large distances), local-area-networks (e.g., LANs, private gaming networks), file sharing networks, social networks, etc.

Multiple users can be connected to the networks via computing devices, such as mobile phones or tablets, desktop or laptop computers, or any other device capable of communication over one or more data networks. The network 400 may have a variety of configurations, and may comprise wired, wireless or a combination of wired and wireless communication pathways. Depending upon the configuration of the network 400, the network may comprise a wide variety of components. For example, the network 400 may include wireless communication relays or transceivers. The network 400 may also include one or more hubs or routers. The network 400 may include dedicated or public lines. For example, one or more portions of the network 400 may include the Internet, phone lines or the like. In general, the network 400 is simply adapted to permit the transmission of data or information between the platform server 100, account server 200, and user interface 300.

The platform server 100 can host a website that provides the various components, i.e., modules, of the system via the internet (400) and/or other computer networks. The platform server 100 can include other devices, servers, mechanisms, etc., that provide functionality (e.g., controls, web pages, applications, etc.) that web users can use to connect to the website and utilize website features (e.g., communications mechanisms, applications, etc.). The platform server 100 can include a memory 120 that may store at least one module 135a, 135b, etc. of the system (software application), a license manager 130, and a processor 110 that may execute the computer-executable instructions of the at least one module 135.

The account server 200 can store data on a memory 220 for user accounts in an account database 230, and a processor 210 that may execute computer executable instructions that allow a user to create and manage an account, i.e., an account setup module 235. The platform server 100 and account server 200 may be separate as shown or may be part of the same computing device (i.e., the same server).

When the system is configured to allow varied access levels to the risk data types, or to various different functionalities of the system, the license manager may track what data and functionalities a user or group may access (i.e., basic, and MVP subscriptions to the system).

The user may interact with the platform server 100 and the account server 200 via a user interface 300 (i.e., a website) over the network 400. The user interface 300 allows the user to create an account and select user and/or group characteristics that define preferred risk avoidance limits, travel planning, access to alerts and notifications, etc., as discussed hereinabove (i.e., any of the dashboards and screens, such as shown in FIG. 8).

The following aspects are provided by the present disclosure:

Aspect 1: A method for safety tracking, the method comprising: accessing safety-related information that is indexed by geographic region; retrieving a user risk threshold for a first user; comparing the user risk threshold to the safety related information for a specific geographic location; and communicating with the first user either of (a) an action alert indicating a first action when the safety related information is less than the user risk threshold and a second action when the safety related information is greater than the user risk threshold, or (b) a map representation of at least the specific geographic region with a heat map overlay that presents a risk level based on the comparing.

Aspect 2: The method of aspect 1, further comprising: before accessing the safety-related information, allowing the first user to grade a plurality of risk data fields of the safety related information to create the user risk threshold.

Aspect 3: The method according to aspect 1 or 2, wherein the safety related information comprises risk data fields related to one or more of crime statistics, emergencies, disease outbreaks, weather conditions, medical service locations, medical supply locations, fuel supply locations, and food supply locations.

Aspect 4: The method according to any preceding aspect, further comprising: receiving an acknowledgement from the first user that the second action notification has been received, and in the event that the acknowledgment is not received, communicating an alert with at least one second user.

Aspect 5: The method according to any preceding aspect, further comprising: receiving a destination location and an origination location of the first user; generating an optimal route from the origination location to the destination location using, in part, the safety-related information, wherein the optimal route is based on a route length and an aggregate risk factor; and communicating the optimal route as a route overlay on the map representation, wherein the origination location may be a current geographic location of the first user or a user selected geographic location.

Aspect 6: The method of aspect 5, wherein the aggregate risk factor comprises aggregated safety related information for positions along a test route between the current geographic location and the destination location, and wherein the optimal route is the test route having the lowest combined route length and aggregate risk factor.

Aspect 7: The method of aspect 5 or 6, further comprising: communicating an alert to the first user and/or at least one second user when the current geographic location deviates from the optimal route.

Aspect 8: The method according to any one of aspects 5 to 7, further comprising: communicating a location of the first user at least one second user during transit of the first user on the route.

Aspect 9: The method according to any preceding aspect, wherein the user risk threshold comprises user selected risk levels for each of a plurality of risk data fields of the safety related information.

Aspect 10: The method according to any preceding aspect, wherein the user profile further comprises a user persona score based on user characteristics, and the comparing further comprises comparing the user risk threshold and the user persona score to the safety related information for a specific geographic location.

Aspect 11: The method of aspect 10, wherein the user characteristics include one or more of user age, user gender, user health status, and user mobility.

Aspect 12: The method of aspect 10 or 11, wherein the user persona score comprises preset risk levels for each of a plurality of data fields of the safety related information.

Aspect 13: The method according to any one of aspects 10 to 12, wherein a second user selects the user persona score and the user risk score for each member of a group of users, or for the group of users.

Aspect 14: One or more computer storage media having computer-executable instructions embodied thereon that, when executed, perform a method for safety tracking according to any one of aspects 1 to 13.

Aspect 15: A personal safety tracking and notification system comprising: a server coupled to a wireless network and configured to communicate with a plurality of client devices, wherein the server is coupled to a database comprising safety-related information compiled from at least one data source and indexed by geographic region, and is further coupled to a processor configured to execute instructions that perform the method for safety tracking method according to any one of aspects 1 to 13.

Aspect 16: A personal safety tracking and notification system comprising: a server coupled to a wireless network and configured to communicate with a plurality of client devices, wherein the server is coupled to a database comprising safety-related information compiled from at least one data source and indexed by geographic region, and is further coupled to a processor configured to execute instructions that perform the method for safety tracking according method, wherein the method comprises receiving a signal of a current geographic location of a client device; accessing the safety-related information from the database for the current geographic location; retrieving a user profile from the database for a user of the client device, wherein the user profile comprises a user risk threshold; comparing the user risk threshold to the safety related information for the current geographic location; and generating a graphical user interface (GUI) on the client device of the user, wherein the GUI presents either of (a) a binary output for the current geographic location based on the comparing, wherein the binary output indicates a safe notification when the safety related information is less than the user risk threshold and an unsafe notification when the safety related information is greater than the user risk threshold, or (b) a risk overlay on a map representation of at least the current geographic location, wherein the risk overlay presents a heat map based on the comparing.

All documents cited herein are incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to the systems and methods described herein.

What is claimed is:

1. One or more computer storage media having computer-executable instructions embodied thereon that, when executed, perform a method for safety tracking, the method comprising:
accessing safety-related information from a data store on a server database, the safety-related information being compiled from at least one data source and being indexed by geographic region;
retrieving a user profile from the server database, wherein the user profile comprises a user risk threshold;
comparing the user risk threshold to the safety related information for a specific geographic location; and
generating a graphical user interface (GUI) on a client device, wherein the GUI presents either of (a) a binary output for the specific geographic region based on the comparing, wherein the binary output indicates a first action when the safety related information is less than the user risk threshold and a second action when the safety related information is greater than the user risk threshold, or (b) a risk overlay on a map representation of at least the specific geographic region, wherein the risk overlay presents a heat map based on the comparing.

2. The computer storage media of claim 1, wherein the safety related information comprises data fields related to one or more of crime statistics, emergencies, disease outbreaks, weather conditions, medical service locations, medical supply locations, fuel supply locations, and food supply locations.

3. The computer storage media of claim 1, wherein the specific geographic region is a current geographic location of the client device, and wherein the first action is a stay notification that the specific geographic region is safe and the second action is a leave notification that the specific geographic region is unsafe.

4. The computer storage media of claim 3, wherein the method further comprises:
receiving an acknowledgement signal from the client device when the leave notification is provided thereon, and in the event that the acknowledgment signal is not received, sending an alert signal to at least one second client device.

5. The computer storage media of claim 1, wherein the specific geographic region is a user selected geographic region.

6. The computer storage media of claim 1, wherein the method further comprises:
receiving a user entered destination location and one of a user entered origination location or an origination location of the client device provided by a global positioning sensor of the client device;
generating a route from the origination location to the destination location using, in part, the safety-related information; and
representing the route as a route overlay on the map representation of the GUI on the client device.

7. The computer storage media of claim 6, wherein the specific geographic location is a current geographic location of the client device, and the method further comprises:
sending an alert to the client device and/or a second client device when the current geographic location deviates from the route.

8. The computer storage media of claim 7, wherein the method further comprises:
representing a location of the client device on a second client device during transit on the route.

9. The computer storage media of claim 1, wherein the specific geographic location is a current geographic location of the client device, and the method further comprises:
sending an alert to a second client device when the safety related information is greater than the user risk threshold.

10. The computer storage media of claim 1, wherein the user risk threshold comprises user selected risk levels for each of a plurality of data fields of the safety related information.

11. The computer storage media of claim 1, wherein the user profile further comprises a user persona score based on user characteristics, and the comparing further comprises comparing the user risk threshold and the user persona score to the safety related information for a specific geographic location.

12. The computer storage media of claim 11, wherein the user characteristics include one or more of user age, user gender, user health status, and user mobility.

13. The computer storage media of claim 11, wherein the user persona score comprises preset risk levels for each of a plurality of data fields of the safety related information.

14. The computer storage media of claim 11, wherein a second user selects the user persona score and the user risk score for each member of a group of users, or for the group of users.

15. The computer storage media of claim 1, wherein the method further comprises:
signaling the client device to activate sensors thereon when the safety related information is greater than the user risk threshold, wherein the sensors comprise one or more of an accelerometer, a gyroscope, a thermometer, a barometer, a proximity sensor, a compass, an ambient light sensor, a camera, an audio recorder, and a posture sensor.

16. The computer storage media of claim 1, wherein the method further comprises:
signaling the client device to activate sensors thereon, wherein the sensors comprise one or more of an accelerometer, a gyroscope, a thermometer, a barometer, a proximity sensor, a compass, an ambient light sensor, a camera, an audio recorder, and a posture sensor;
recording data from at least one of the activated sensors; and
comparing the recorded data to a reference data,
wherein if the recorded data deviates from the reference data an alert notification is sent to a second client device.

17. The computer storage media of claim 1, wherein data included in the safety related information is verified based on predetermined validation criteria, wherein the predetermined validation criteria comprises either or both of a total number of data points in a data set and a percentage of data points that are out of a set standard deviation limit.

18. A personal safety tracking and notification system comprising:
a server coupled to a wireless network and configured to communicate with a plurality of client devices, wherein the server is coupled to a database comprising safety-related information compiled from at least one data source and indexed by geographic region, and is further coupled to a processor configured to execute instructions that perform a method for safety tracking, the method comprising:
receiving a signal of a current geographic location of a client device;
accessing the safety-related information from the database for the current geographic location;
retrieving a user profile from the database for a user of the client device, wherein the user profile comprises a user risk threshold;
comparing the user risk threshold to the safety related information for the current geographic location; and
generating a graphical user interface (GUI) on the client device of the user, wherein the GUI presents either of (a) a binary output for the current geographic location based on the comparing, wherein the binary output indicates a safe notification when the safety related information is less than the user risk threshold and an unsafe notification when the safety related information is greater than the user risk threshold, or (b) a risk overlay on a map representation of at least the current geographic location, wherein the risk overlay presents a heat map based on the comparing.

19. The system of claim 18, wherein the safety related information comprises data fields related to one or more of crime statistics, emergencies, disease outbreaks, weather conditions, medical service locations, medical supply locations, fuel supply locations, and food supply locations.

20. The system of claim 18, wherein the method further comprises:
receiving an acknowledgement signal from the client device when the unsafe notification is provided thereon, and in the event that the acknowledgment signal is not received, sending an alert signal to at least one second client device.

21. The system of claim 18, wherein the method further comprises:
receiving a user entered destination location and the current geographic location of the client device;
generating an optimal route from the current geographic location to the destination location using, in part, the safety-related information, wherein the optimal route is based on a route length and an aggregate risk factor; and
representing the optimal route as a route overlay on the map representation of the GUI on the client device.

22. The system of claim 21, wherein the aggregate risk factor comprises aggregated safety related information for positions along a test route between the current geographic location and the destination location, and wherein the optimal route is the test route having the lowest combined route length and aggregate risk factor.

23. The system of claim 21, wherein the method further comprises:
sending an alert to the client device and/or a second client device when the current geographic location deviates from the optimal route.

24. The system of claim 21, wherein the method further comprises:
representing a location of the client device on a second client device during transit on the route.

25. The system of claim 18, wherein the user risk threshold comprises user selected risk levels for each of a plurality of data fields of the safety related information.

26. The system of claim 18, wherein the user profile further comprises a user persona score based on user characteristics, and the comparing further comprises comparing the user risk threshold and the user persona score to the safety related information for a specific geographic location.

27. The system of claim 26, wherein the user characteristics include one or more of user age, user gender, user health status, and user mobility.

28. The system of claim 26, wherein the user persona score comprises preset risk levels for each of a plurality of data fields of the safety related information.

29. The system of claim 26, wherein a second user selects the user persona score and the user risk score for each member of a group of users, or for the group of users.

30. The system of claim 18, the method further comprising:
signaling the client device to activate sensors thereon when the safety related information is greater than the user risk threshold, wherein the sensors comprise one or more of an accelerometer, a gyroscope, a thermometer, a barometer, a proximity sensor, a compass, an ambient light sensor, a camera, an audio recorder, and a posture sensor; and
recording data from at least one of the activated sensors.

31. The system of claim 18, wherein the method further comprises:
signaling the client device to activate sensors thereon, wherein the sensors comprise one or more of an accelerometer, a gyroscope, a thermometer, a barometer, a proximity sensor, a compass, an ambient light sensor, a camera, an audio recorder, and a posture sensor;
recording data from at least one of the activated sensors; and
comparing the recorded data to a reference data,
wherein if the recorded data deviates from the reference data an alert notification is sent to a second client device.

32. The system of claim 18, wherein data included in the safety related information is verified based on predetermined validation criteria, wherein the predetermined validation criteria comprises either or both of a total number of data points in a data set and a percentage of data points that are out of a set standard deviation limit.

33. A method for safety tracking, the method comprising:
accessing safety-related information that is indexed by geographic region;
retrieving a user risk threshold for a first user;
comparing the user risk threshold to the safety related information for a specific geographic location; and
communicating with the first user either of (a) an action alert indicating a first action when the safety related information is less than the user risk threshold and a second action when the safety related information is greater than the user risk threshold, or (b) a map representation of at least the specific geographic region with a heat map overlay that presents a risk level based on the comparing.

34. The method of claim 33, further comprising:
before accessing the safety-related information, allowing the first user to grade a plurality of risk data fields of the safety related information to create the user risk threshold.

35. The method of claim 33, wherein the safety related information comprises risk data fields related to one or more of crime statistics, emergencies, disease outbreaks, weather conditions, medical service locations, medical supply locations, fuel supply locations, and food supply locations.

36. The method of claim 33, further comprising:
receiving an acknowledgement from the first user that the second action notification has been received, and in the event that the acknowledgment is not received, communicating an alert with at least one second user.

37. The method of claim 33, further comprising:
receiving a destination location and an origination location of the first user;
generating an optimal route from the origination location to the destination location using, in part, the safety-related information, wherein the optimal route is based on a route length and an aggregate risk factor; and
communicating the optimal route as a route overlay on the map representation,
wherein the origination location may be a current geographic location of the first user or a user selected geographic location.

38. The method of claim 37, wherein the aggregate risk factor comprises aggregated safety related information for positions along a test route between the current geographic location and the destination location, and wherein the optimal route is the test route having the lowest combined route length and aggregate risk factor.

39. The method of claim 37, further comprising:
communicating an alert to the first user and/or at least one second user when the current geographic location deviates from the optimal route.

40. The method of claim 37, further comprising:
communicating a location of the first user at least one second user during transit of the first user on the route.

41. The method of claim 33, wherein the user risk threshold comprises user selected risk levels for each of a plurality of risk data fields of the safety related information.

42. The method of claim 33, wherein the user profile further comprises a user persona score based on user characteristics, and the comparing further comprises comparing the user risk threshold and the user persona score to the safety related information for a specific geographic location.

43. The method of claim 42, wherein the user characteristics include one or more of user age, user gender, user health status, and user mobility.

44. The method of claim 42, wherein the user persona score comprises preset risk levels for each of a plurality of data fields of the safety related information.

45. The method of claim 42, wherein a second user selects the user persona score and the user risk score for each member of a group of users, or for the group of users.
